(19) United States
(12) Patent Application Publication
(10) Pub. No.: US 2026/0359863 A1
(43) Pub. Date: Nov. 12, 2026

(54) INFORMATION PROCESSING DEVICE AND METHOD, AND PROGRAM

(71) Applicant: Sony Group Corporation, Tokyo (JP)

(72) Inventors: Takashi Kinoshita, Tokyo (JP); Makoto Yamada Kanagawa, Tokyo (JP)

(73) Assignee: Sony Group Corporation, Tokyo (JP)

(21) Appl. No.: 19/118,554

(22) PCT Filed: Sep. 25, 2023
(86) PCT No.: PCT/JP2023/034647

§ 371 Date: Apr. 4, 2025

(30) Foreign Application Priority Data
Oct. 13, 2022 (JP) 2022-164533

(51) Int. Cl. G06Q 30/0251; H04L 67/52

(52) U.S. Cl. CPC G06Q 30/0261; G06Q 30/0267; H04L 67/52

(57) ABSTRACT

The present technology relates to an information processing device and method, and a program that can provide added values to users.

An information processing device includes: a control unit that, when a user terminal of a user enters a content area, specifies a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and a communication unit that transmits to the user terminal the related content associated with the service area specified by the control unit. The present technology can be applied to a content providing system.

### TECHNICAL FIELD

The present technology relates to an information processing device and method, and a program, and, more particularly, to an information processing device and method, and a program that can provide added values to users.

### BACKGROUND ART

Conventionally, there has been known a system that continuously tracks position information of an individual user, and provides a coupon or an advertisement to the user when detecting entry of the user into an area designated by a business operator for a purpose of guiding the user to an own trading area or store of the business operator.

As a technology related to such a system, there has been proposed, for example, a technology that, every time, for example, a mobile station moves to a radio area managed by a different base station, reports radio area information managed by a base station connected with the mobile station from a higher control device to a server device (see, for example, PTL 1). This technology distributes, to the mobile station, region information of a type that relates to a region in which the mobile station exists, and that is registered by a user of the mobile station in advance.

Furthermore, there has been also proposed a technology that updates an experienceable period based on position information of an advertisement providing store and position information of a user during, for example, the experienceable period during which the user can experience content (see, for example, PTL 2).

### CITATION LIST

### Patent Literature

[PTL 1]
JP 2002-186033A
[PTL 2]
WO 2020/189582

### SUMMARY

### Technical Problem

However, the above-described system frequently provides coupons or advertisements for obviously demanding purchase to users in many examples when the users enter an area, and cannot provide added values of purposes and experience contents of individual users.

With such a situation in view, the present technology can provide added values to users.

### Solution to Problem

An information processing device according to a first aspect of the present technology includes: a control unit that, when a user terminal of a user enters a content area, specifies a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and a communication unit that transmits to the user terminal the related content associated with the service area specified by the control unit.

An information processing method or a program according to the first aspect of the present technology includes the steps of: when a user terminal of a user enters a content area, specifying a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and transmitting to the user terminal the related content associated with the specified service area.

According to the first aspect of the present technology, when the user terminal of the user enters the content area set by the user and providing the element content, the service area overlapping the content area that the user terminal has entered is specified based on the content area setting information indicating the content area, and the service area setting information set by the business operator that provides the related content related to the element content, and indicating the service area in which the related content is provided, and the related content associated with the specified service area is transmitted to the user terminal.

An information processing device according to a second aspect of the present technology is an information processing device that plays back element content or related content related to the element content, and includes: a control unit that sets a content area in which the element content is provided in response to an operation of a user, and detects entry of the information processing device into the content area based on content area setting information indicating the content area; and a communication unit that, when the entry of the information processing device into the content area is detected, receives the related content associated with a service area that is set by a business operator that provides the related content and in which the related content is provided, and that overlaps the content area that the information processing device has entered, and the control unit plays back the received related content.

An information processing method or a program according to the second aspect of the present technology includes the steps of, at an information processing device that plays back element content or related content related to the element content: setting a content area in which the element content is provided in response to an operation of a user, and detecting entry of the information processing device into the content area based on content area setting information indicating the content area; when the entry of the information processing device into the content area is detected, receiving the related content associated with a service area that is set by a business operator that provides the related content and in which the related content is provided, and that overlaps the content area that the information processing device has entered; and playing back the received related content.

According to the second aspect of the present technology, in the information processing device that plays back the element content or the related content related to the element content, the content area in which the element content is provided is set in response to the operation of the user, and the entry of the information processing device into the content area is detected based on the content area setting information indicating the content area, when the entry of the information processing device into the content area is detected, the related content associated with the service area that is set by the business operator that provides the related content and in which the related content is provided, and that overlaps the content area that the information processing device has entered is received, and the received related content is played back.

### BRIEF DESCRIPTION OF DRAWINGS

FIG. 1 is a diagram illustrating a configuration example of a content providing system.

FIG. 2 is a diagram for explaining detection of a behavior of a general user, and offer of a special privilege.

FIG. 3 is a diagram for explaining detection of a behavior of a user, and offer of a special privilege according to the present technology.

FIG. 4 is a diagram for explaining creation and provision of content.

FIG. 5 is a diagram for explaining element content and special content.

FIG. 6 is a diagram for explaining setting of a content area.

FIG. 7 is a diagram for explaining setting of the content area.

FIG. 8 is a diagram for explaining playback of element content.

FIG. 9 is a diagram for explaining playback of special content.

FIG. 10 is a diagram illustrating a display example of a service area.

FIG. 11 is a diagram illustrating a display example of the service area.

FIG. 12 is a diagram illustrating a screen display example where the service area is hidden.

FIG. 13 is a diagram for explaining playback of element content and special content.

FIG. 14 is a diagram illustrating a configuration example of a user terminal.

FIG. 15 is a diagram illustrating a configuration example of a server.

FIG. 16 is a flowchart for explaining content area setting processing and setting information reception processing.

FIG. 17 is a flowchart for explaining content playback processing.

FIG. 18 is a flowchart for explaining content provision processing.

FIG. 19 is a diagram illustrating a configuration example of a computer.

### DESCRIPTION OF EMBODIMENTS

Embodiments to which the present technology is applied will be described below with reference to the accompanying drawings.

### First Embodiment

### <Configuration Example of Content Providing System>

In a case where a content area set by a user and a service area set by a business operator overlap, the present technology can provide an added value to the user while guiding the user to the service area by playing back special content associated with the service area when the user enters the content area.

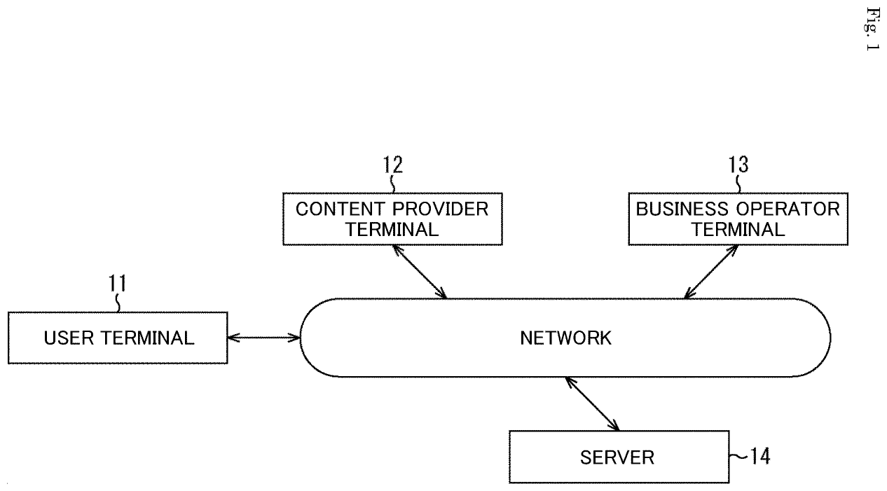

FIG. 1 is a diagram illustrating a configuration example of an embodiment of a content providing system to which the present technology has been applied.

The content providing system illustrated in FIG. 1 includes a user terminal 11, a content provider terminal 12, a business operator terminal 13, and a server 14, and the user terminal 11 to the server 14 can connect with each other via a wired or wireless network.

The user terminal 11 is an information processing device owned by a user who is a user of a content providing service provided by the server 14. More specifically, for example, the user terminal 11 is a smartphone, tablet, a portable device, or the like.

The user terminal 11 receives supply of content provided by the content providing service from the server 14, and plays back the supplied content.

Here, the content provided by the content providing service includes element content and special content that are items of content related to each other, and relates to, for example, one theme such as a theme based on a work such as a game, a movie, music, or a novel. Particularly, the theme described here is not limited to a theme related to a piece of work, and may be, for example, any theme such as a theme that a plurality of works of the same author are “encouraging”, and a theme based on a plurality of works of different authors.

Element content is content associated with a content area set by a user.

That is, the content area is a region in which element content is provided to a user, and, when the user terminal 11 owned by the user enters the content area, element content associated with this content area is played back by the user terminal 11.

Special content is another content, that is, related content that is provided as a special privilege to a user by a business operator and relates to element content.

Particularly, an object of special content is to guide a user to a predetermined service area, and, in addition, provide an additional added value of a theme covered by element content to the user.

A service area is a region in which special content is provided to a user. That is, special content is associated with a service area set by a business operator.

Note that a service area may be associated with a plurality of items of special content, and special content to be provided (played back) may change depending on a use situation or the like of an arbitrary service such as provision of a product by a business operator. That is, one of objects of special content may be to make users use an arbitrary service such as provision of a product provided by a business operator.

When, for example, the user, that is, the user terminal 11 owned by the user enters a content area that overlaps a service area, special content associated with this service area is played back by the user terminal 11.

The content provider terminal 12 is an information processing device such as a personal computer that is operated by a content provider (content creator).

The content provider terminal 12 creates (generates) content provided by the content providing service, that is, element content and special content in response to an operation of the content provider.

The business operator terminal 13 is an information processing device such as a personal computer that is managed by a business operator that provides an arbitrary service.

The business operator terminal 13 designates (selects) content to be provided to a user among items of content created by the content provider terminal 12 (content provider), more particularly, special content making up the content, and designates a service area for the special content.

The server 14 is an information processing device managed by a manager of a content providing service for providing content to the user.

The server 14 records element content and special content created by a content provider, and supplies (transmits) the element content and the special content to the user terminal 11 according to information or the like supplied from the user terminal 11.

Note that the element content does not necessarily need to be supplied by the server 14, and the element content may be supplied to the user terminal 11 by the content provider terminal 12 or another server different from the server 14.

### <Playback of Content>

Next, playback of content provided by the content providing service will be described.

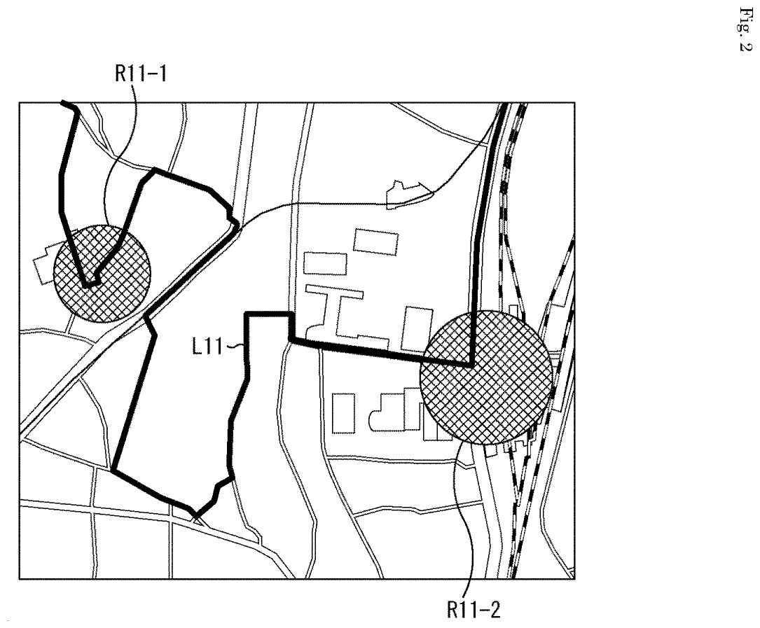

First, offer of a special privilege of a general service will be described with reference to FIG. 2.

In the general service, position information of an individual user is detected, that is, a behavior of the user is detected at all times.

For example, a polyline L11 in FIG. 2 indicates a trajectory of a position of a user, and a server side that provides a service and a terminal side of the user can grasp such a trajectory of the position (movement) of the user from position information of the user at each time.

Furthermore, in the general service, a service provider sets a plurality of service areas such as a service area R11-1 and a service area R11-2.

Note that, in a case where the service area R11-1 and the service area R11-2 do not particularly need to be distinguished, the service area R11-1 and the service area R11-2 will be also referred to simply as a service area R11.

Each service area R11 is associated with a coupon or the like to be provided to the user, and, when the user enters the service area R11, a terminal owned by the user receives supply of the coupon or the like associated with this service area R11. That is, the terminal of the user displays a special privilege such as a coupon.

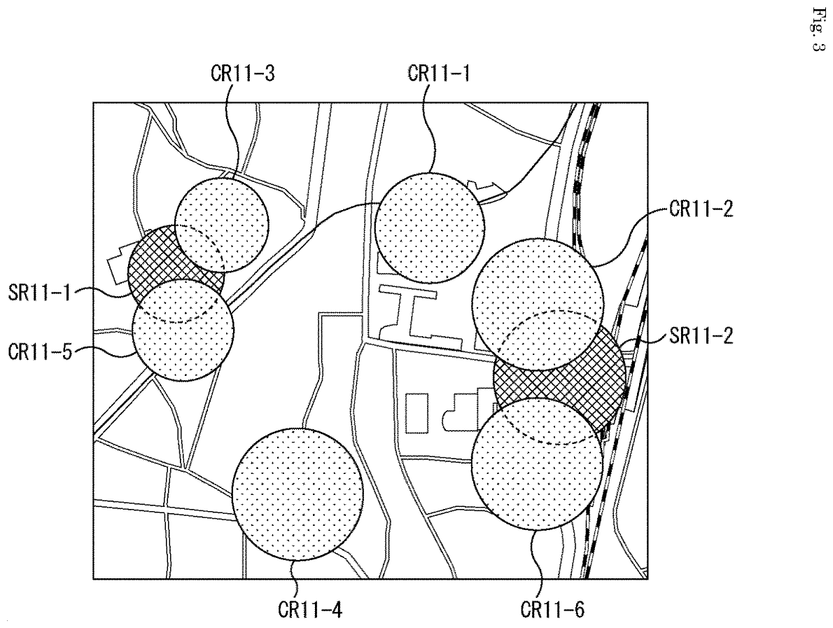

By contrast with this, the content providing system according to the present technology provides a special privilege as illustrated in, for example, FIG. 3.

In an example illustrated in FIG. 3, content areas and service areas are set targeting at an arbitrary space such as an urban area.

Here, six content area CR11-1 to content area CR11-6 are set by the user, and two service area SR11-1 and service area SR11-2 are set by the business operator.

Hereinafter, in a case where the content area CR11-1 to the content area CR11-6 do not particularly need to be distinguished, the content area CR11-1 to the content area CR11-6 will be also referred to simply as a content area CR11, and, in a case where the service area SR11-1 and the service area SR11-2 do not particularly need to be distinguished, the service area SR11-1 and the service area SR11-2 will be referred to simply as a service area SR11.

Note that description will be given assuming an example of a case where a space that is a setting target of the content areas CR11 and the service areas SR11 is an urban area. However, the content areas CR11 and the service areas SR11 are not limited to this, and, for example, a space in a facility such as a theme park or a shopping mall, and a space of a building interior of a building, a home, or the like may be setting target spaces (regions) of the content areas CR11 and the service areas SR11.

According to the present technology, when the user instructs start of use of the content providing service, the user terminal 11 side starts detecting position information of the user terminal 11, that is, detecting entry of the user into the content area CR11 (detecting a user's behavior).

Then, when the user, that is, the user terminal 11 enters the content area CR11, the user terminal 11 transmits to the server 14 entry sensing information indicating that the entry into the content area CR11 has been detected, and plays back special content as a special privilege as appropriate.

More specifically, in a case where the content area CR11 that the user terminal 11 has entered and the service area SR11 do not overlap, element content associated with this content area CR11 is played back by the user terminal 11.

By contrast with this, in a case where the content area CR11 that the user terminal 11 has entered and the service area SR11 overlap, special content associated with the service area SR11 overlapping this content area CR11 is played back by the user terminal 11.

Hence, when, for example, the user terminal 11 enters the content area CR11-1, element content associated with this content area CR11-1 is played back.

Furthermore, when, for example, the user terminal 11 enters the content area CR11-3, special content associated with the service area SR11-1 overlapping this content area CR11-3 is played back.

Upon comparison between the content providing service according to the present technology described with reference to FIG. 3 and a general service illustrated in FIG. 2, the content providing service according to the present technology provides following advantages.

That is, according to the general service, position information of the user is continuously tracked (sensed) to sense entry of the user into the service area R11 designated by the business operator.

Furthermore, although there has been also proposed a method where a user determines a range for tracking position information, the user only defines a geographical range, and the position information is acquired at all times irrespectively of a purpose of a user's behavior, which is not desirable from a viewpoint of privacy.

By contrast with this, according to the content providing service according to the present technology, the user sets the content areas CR11. That is, the user can explicitly set one or a plurality of the content areas CR11 as places for tracking the position information.

Consequently, only when the user terminal 11 enters the content area CR11 set by the user, the entry sensing information is transmitted to the server 14, and the user can also clearly grasp that, when the user is at what place, the entry sensing information is transmitted to the server 14.

Moreover, only when the content providing service is used, that is, when there is a behavior purpose of viewing content, the position information is sensed (entry into the content area CR11 is detected).

In view of these, the content providing service according to the present technology is more useful than the general service from a viewpoint of privacy protection.

Furthermore, according to the general service, a coupon or the like for obviously demanding purchase is provided to users in many examples, and added values cannot be provided for a purpose and experience contents of an individual user.

By contrast with this, according to the content providing service according to the present technology, special content related to the same theme (work) as that of element content is provided for a user's purpose or experience of viewing this element content. That is, it is possible to provide content that is needed by each user as a special privilege (special content).

Consequently, it is possible to provide added values for a purpose and experience contents of an individual user while guiding the user to the service area SR11. In other words, it is possible to make the user feel that content is upgraded with special content, and improve a feeling of satisfaction. Particularly, in this case, the special content is content having the same theme as that of the element content, so that a user's sense of immersion related to viewing of content is not undermined unlike a case where a coupon or an advertisement is presented.

Furthermore, as for offer of special privileges of contents directly related to products or services of business operators such as offer of coupons or the like performed by the general service, users who desire offer of special privileges are limited to users who aim at target products or services from the beginning. Therefore, it is not possible to increase the number of accesses from the business operators to new users who do not fall in a use range of coupons or the like.

By contrast with this, according to the content providing service according to the present technology, special content related to element content is provided instead of a coupon, so that it is possible to increase the number of accesses from business operators to users who do not directly have business with the business operators that provide the special content.

That is, a special privilege to be offered is not a coupon, but special content, so that more diverse and more business operators can join the content providing service.

If, for example, a coupon is offered as a special privilege, participant business operators of the general service are limited to business operators that provide this coupon, that is, business operators that have stores in the service area R11.

By contrast with this, according to the content providing service according to the present technology, for example, not only the business operators that have the stores in the service area SR11, but also more diverse business operators such as other business operators that provide products or the like to be sold in these stores, and other business operators that collaborate with the business operators having the stores can become participant business operators.

Moreover, it is possible to lead to the service area SR11 not only users who directly have business with the business operators, but also users who are interested in element content even though the users do not directly have business with the business operators.

### <Creation and Provision of Content>

Hereinafter, creation and provision of content by the content providing system according to the present technology will be described.

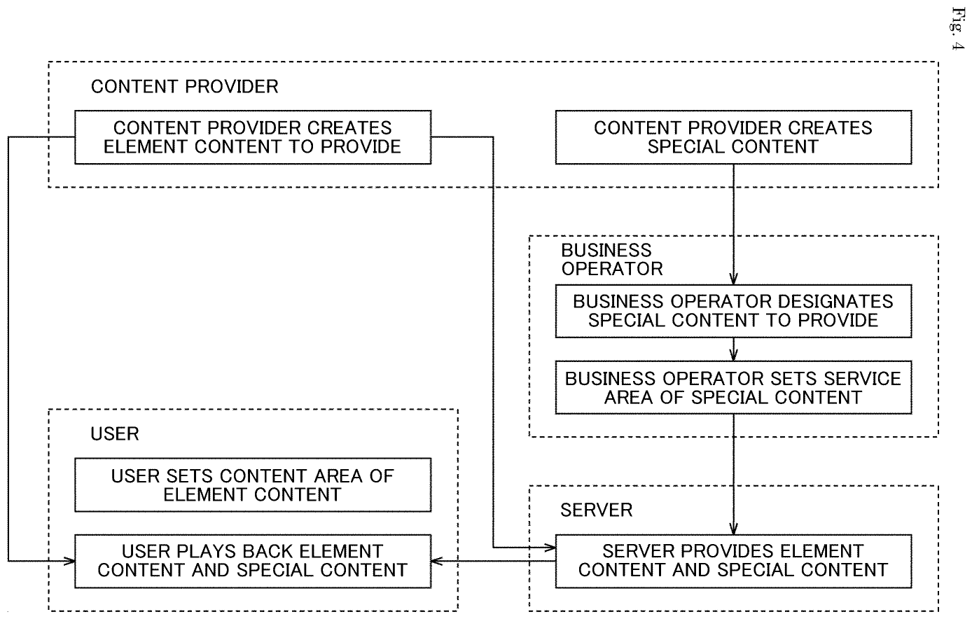

As illustrated on, for example, an upper side in FIG. 4, a content provider, that is, the content provider terminal 12 creates element content and special content as content.

The element content created by the content provider terminal 12 is supplied to the user terminal 11 of the user directly from the content provider terminal 12 or via the server 14.

For example, the user terminal 11 may download the element content from the content provider terminal 12 or the server 14 in advance, or the element content may be streamed from the content provider terminal 12 or the server 14 to the user terminal 11.

Hereinafter, description will be given assuming that the server 14 streams the element content to the user terminal 11. Accordingly, the created element content is first supplied from the content provider terminal 12 to the server 14 and recorded.

Furthermore, the special content created by the content provider terminal 12 is provided to a business operator, that is, the business operator terminal 13.

Then, the business operator terminal 13 designates (selects) one or a plurality of items of special content to provide to the user from one or a plurality of items of special content provided from the content provider.

Furthermore, the business operator terminal 13 sets a service area to each designated special content, and generates service area setting information indicating a setting result.

Furthermore, for special content, the business operator terminal 13 generates, as appropriate, selection condition information indicating a condition (selection condition) that this special content is selected as special content to be played back.

For example, the selection condition indicated by the selection condition information is that a user has purchased a predetermined product provided by a business operator or a period corresponds to a predetermined provision period.

Consequently, in a case where, for example, one service area is associated with a plurality of items of special content, it is also possible to select and play back one special content based on the selection condition information from among these items of special content.

The business operator terminal 13 supplies the special content, the service area setting information, and the selection condition information to the server 14 to cause the server 14 to record.

Note that a business operator may differ per special content, or the same special content may be provided to users by each of a plurality of business operators.

Furthermore, the business operator terminal 13 may generate unique presentation information for presenting a unique presentation image to a user together with the special content, and supply the unique presentation information to the server 14 to cause the server 14 to record.

The unique presentation information is, for example, image information for presenting information unique to a business operator as the unique presentation image such as an advertisement of a service or the like provided by the business operator. Particularly, the unique presentation information described here is data (image data) for presenting unique information using an image, and is not data (voice data) for presenting information using a voice or the like.

The server 14 records content information including at least the special content, the service area setting information, and the selection condition information supplied from the business operator terminal 13, and the element content supplied from the content provider terminal 12. This content information may include the above-described unique presentation information and the like.

Furthermore, as illustrated in a lower left in FIG. 4, the user operates the user terminal 11, and sets a content area of each element content using a user interface.

The user terminal 11 records content area setting information indicating a set content area, and supplies the content area setting information to the server 14 to cause the server 14 to record.

As described above, when the content area setting information of each user and the content information of the content are recorded in the server 14, the user can view the content using the content providing service provided by the server 14.

When, for example, the user terminal 11 starts using the content providing service by, for example, starting a dedicated application program according to a user's instruction, the user terminal 11 starts detecting an own position.

Furthermore, the user terminal 11 detects (senses) entry of the user (user terminal 11) into the content area based on the detected position and the recorded content area setting information.

When entry of the user into the content area is detected, the user terminal 11 generates the entry sensing information indicating a detection result, and transmits the entry sensing information to the server 14.

The entry sensing information is, for example, information that makes it possible to specify which content area associated with which element content the user has entered such as ID information indicating a content area in which entry of a user has been detected (sensed).

When receiving the entry sensing information from the user terminal 11, the server 14 specifies whether or not there is a service area that overlaps the content area that the user has entered based on this entry sensing information, and the recorded content information and content area setting information.

Furthermore, in a case where there is no service area that overlaps a content area that the user has entered, the server 14 transmits to the user terminal 11 element content associated with this content area, more specifically, data (hereinafter, also referred to as element content playback data) for playing back element content. Consequently, the user terminal 11 plays back the element content.

By contrast with this, in a case where there is a service area that overlaps a content area that the user has entered, the server 14 transmits to the user terminal 11 special content associated with this service area, more specifically, data (hereinafter, also referred to as special content playback data) for playing back special content. Consequently, the user terminal 11 plays back the special content.

Next, the content providing system according to the present technology, that is, a specific example of content provided by the content providing system will be described.

The content provided by the content providing service includes a plurality of items of element content and special content that are assumed to be arranged in different areas.

The content is provided to a user as one theme that is based on a work such as a game, a movie, music, or a novel.

It is considered in one example that, for example, one game is a theme, and each of a plurality of scenes included in this game is provided as each of a plurality of items of element content. In this case, special content is created based on a theme that is a game covered by the element content.

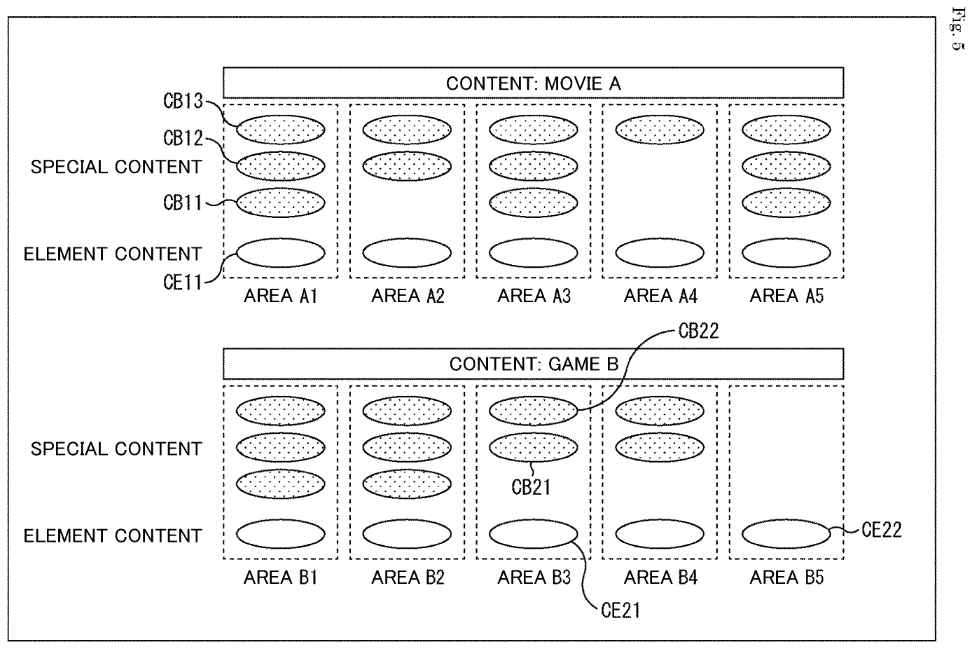

FIG. 5 illustrates an example of element content and special content that make up content.

An upper side in FIG. 5 illustrates an example of content where a movie A is a theme.

In this content, five area A1 to area A5 are defined, and one element content and one or a plurality of items of special content are associated with each area. That is, element content and special content are defined per area.

For example, the area A1 is associated with one element content CE11, and three special content CB11 to special content CB13.

In this case, the user sets a content area associated with the area A1, and the business operator sets a service area associated with the area A1.

Note that, when special content associated with the area A1 (service area) is played back, special content to be played back is selected from the special content CB11 to the special content CB13 based on, for example, the above-described selection condition information or the like.

Furthermore, a lower side in FIG. 5 illustrates an example of content where a game B is a theme.

In this content, five area B1 to area B5 are defined, and one element content is associated with each of these areas. Furthermore, the area B1 to the area B5 include an area associated with one or a plurality of items of special content, and an area associated with special content.

For example, the area B3 is associated with one element content CE21 and two special content CB21 and special content CB22. On the other hand, the area B5 is associated with only the one element content CE22, and is not associated with special content.

As described above, one element content is defined for each area without fail, and special content can be defined (added) for these areas as needed.

Particularly, a plurality of items of special content can be defined for one area, and special content can be left undefined for an area.

Furthermore, element content and special content, that is, element content playback data and special content playback data include at least one data.

More specifically, element content includes at least one of an image and a voice. In other words, the element content may be a still image, may be a moving image (video), that is, video content, or may be audio content (sound content) including only a voice.

Particularly in a case where element content is video content, the element content may or may not include a voice accompanying the moving image (video). Furthermore, the voice described here is not limited to a voice of a character or the like, and is an arbitrary sound such as a song, a sound effect, or a background sound.

In a case where, for example, element content is a moving image including a voice, image data of the moving image, and voice data (audio data) of a voice accompanying this moving image are element content playback data. Note that an image as element content may include a text as an element to be displayed, and an image (text image) that displays, for example, only a text can be also element content. Accordingly, the element content can include at least one of an image, a voice, and a text.

Furthermore, special content also includes at least one of an image and a voice similarly to the element content. In other words, similarly to the case of the element content, the special content also includes at least one of an image, a voice, and a text.

### <Content Area and Service Area>

As described above, the user can set a content area of each content area using a user interface.

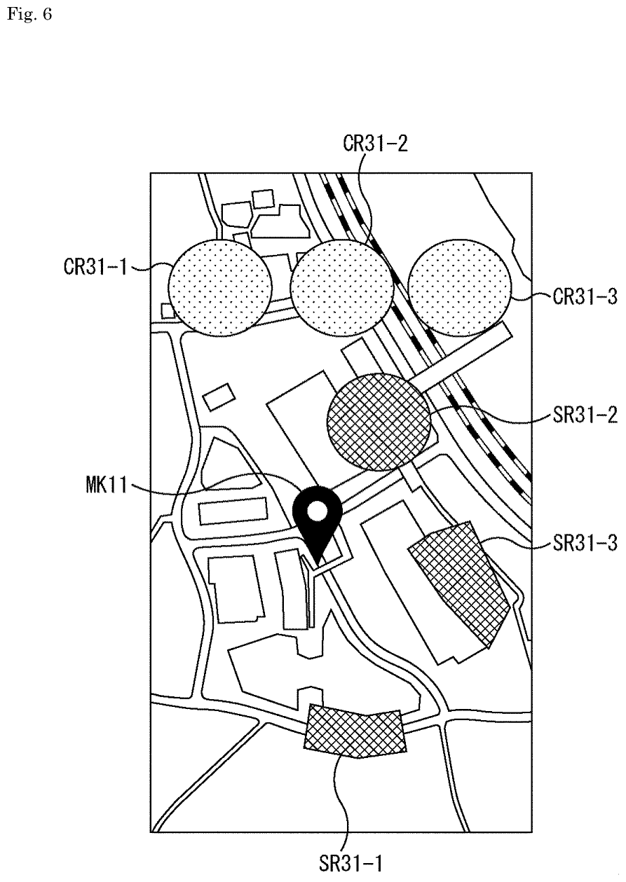

When the user terminal 11 starts an application program for using the content providing service, the user terminal 11 displays, for example, a map screen illustrated in FIG. 6.

In this example, the map screen displays as a map screen a map of an urban area in which the user, that is, the user terminal 11 owned by the user is located.

Furthermore, a current position mark MK11 indicating a current position of the user, a content area CR31-1 to a content area CR31-3, and a service area SR31-1 to a service area SR31-3 are displayed on the map screen.

Hereinafter, in a case where the content area CR31-1 to the content area CR31-3 do not particularly need to be distinguished, the content area CR31-1 to the content area CR31-3 will be also referred to simply as a content area CR31. Furthermore, in a case where the service area SR31-1 to the service area SR31-3 do not particularly need to be distinguished, the service area SR31-1 to the service area SR31-3 will be referred to simply as a service area SR31.

By operating the user terminal 11 and designating arrangement positions and the sizes of the content areas CR31, the user sets the content area CR31 associated with each element content.

In this case, for example, by designing the content area CR31 by a tapping operation or the like, the user can display information related to the content area CR31 and indicating which element content this content area CR31 is associated with.

Note that the user may be able to change the shapes of the content areas CR31. Furthermore, when the user sets (edits) the content areas CR31 or when the user plays back content after setting, the service areas SR31 may not be displayed.

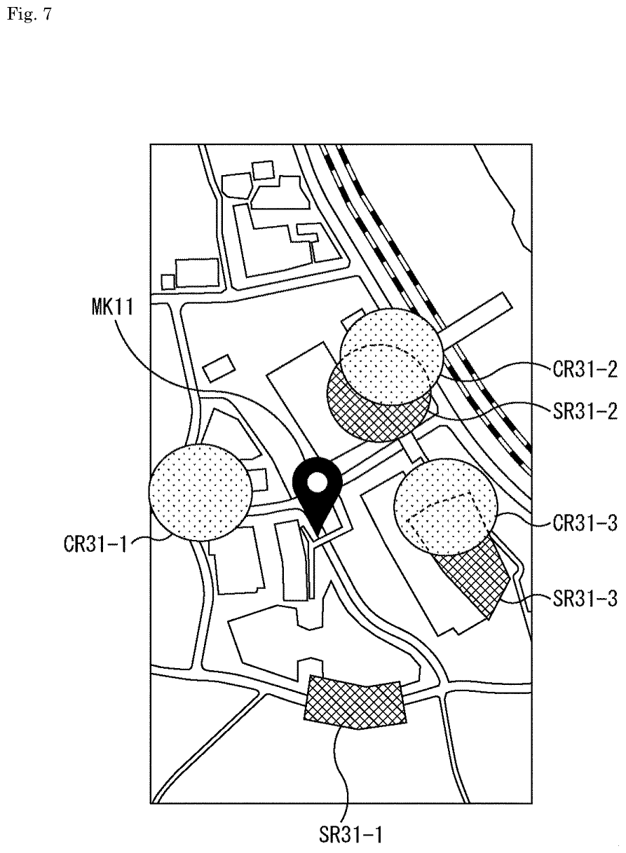

For example, it is assumed that the user sets the content areas CR31 as illustrated in FIG. 7 by, for example, moving the content areas CR31.

In an example illustrated in FIG. 7, the content area CR31-1 does not overlap the any service area SR31. By contrast with this, the content area CR31-2 overlaps the service area SR31-2, and the content area CR31-3 overlaps the service area SR31-3.

When the user instructs start of use of the content providing service, that is, start of playback of content after setting the content areas CR31 in this way and, the user moves in an urban area, the current position mark MK11 on the map screen also moves in response to movement of the user.

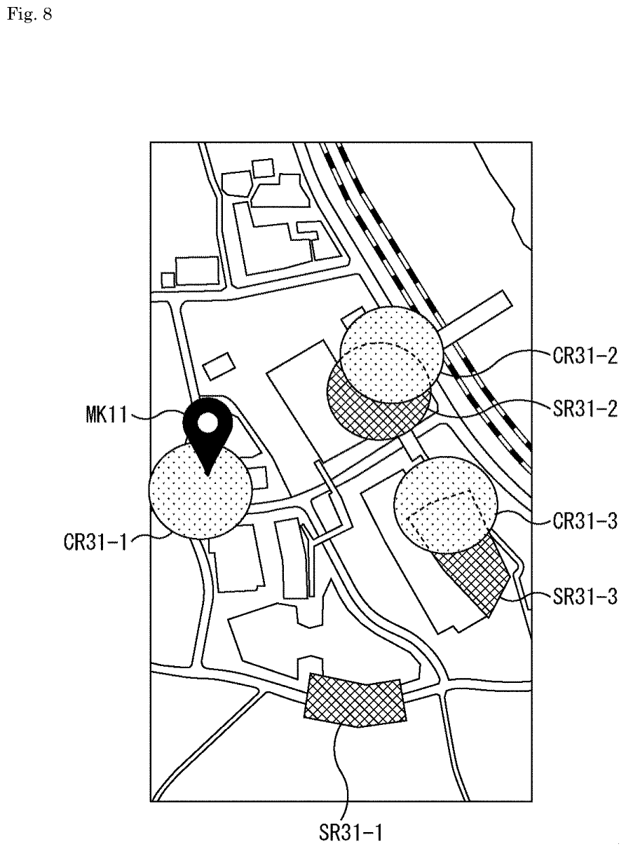

Furthermore, for example, it is assumed that the state illustrated in FIG. 7 transitions to a state illustrated in FIG. 8.

In an example illustrated in FIG. 8, the current position mark MK11 is located in the content area CR31-1. Thus, entry of the user into the content area CR31-1 is detected in this example.

In this case, since the content area CR31-1 does not overlap any one of the service areas SR31, element content associated with the content area CR31-1 is played back by the user terminal 11.

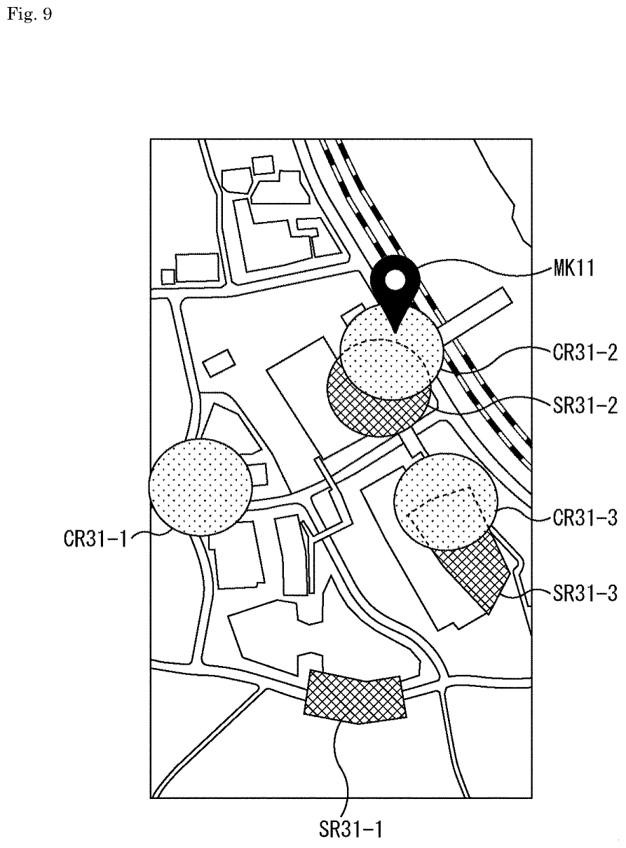

By contrast with this, for example, it is assumed that the state illustrated in FIG. 7 transitions to a state illustrated in FIG. 9.

In an example illustrated in FIG. 9, the current position mark MK11 is located in the content area CR31-2. Thus, entry of the user into the content area CR31-2 is detected in this example.

In this case, since the content area CR31-2 overlaps the service area SR31-2, special content associated with the service area SR31-2 is played back by the user terminal 11.

Note that, when element content or special content is played back, too, the map screen may be left displayed, or, when element content or special content is played back, the map screen may not be displayed.

Furthermore, the service area on the map screen may be displayed in any display format.

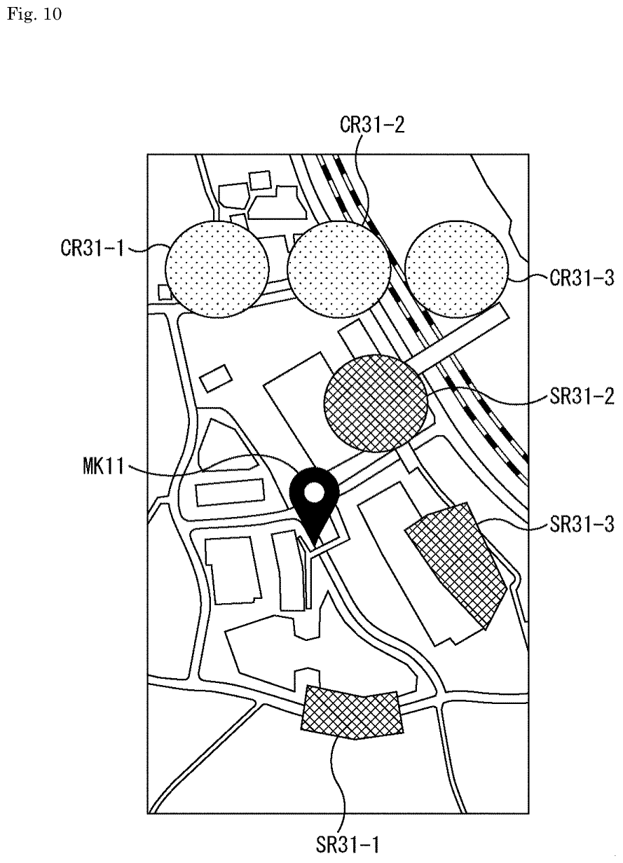

More specifically, as illustrated in, for example, FIG. 10, the service area SR31 can be displayed (presented) in a circular shape or a polygonal shape.

For example, in an example in FIG. 10, the service area SR31-2 has a circular shape, and the service area SR31-3 has a substantially square shape. Note that the shape of the service area SR31 can be an arbitrary shape in accordance with a shape of an area that the business operator needs to set.

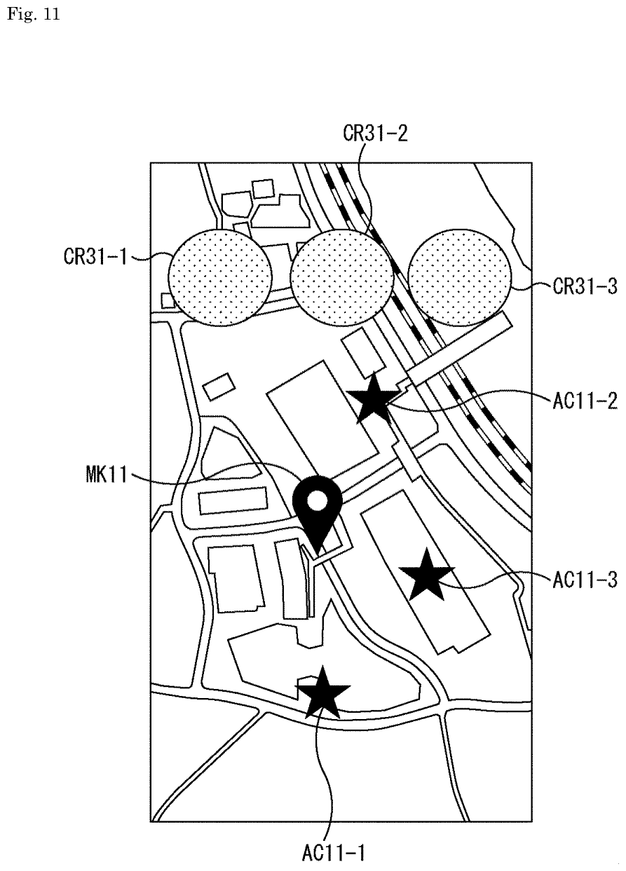

Furthermore, as illustrated in, for example, FIG. 11, star-shaped icon AC11-1 to icon AC11-3 may be displayed as information indicating positions of service areas on the map screen.

In this case, for example, the icon AC11-1 is associated with the service area SR31-1 illustrated in FIG. 10. In an example where the positions of the service areas are presented by such icons, the user can roughly grasp regions that are the service areas based on the icons on the map screen.

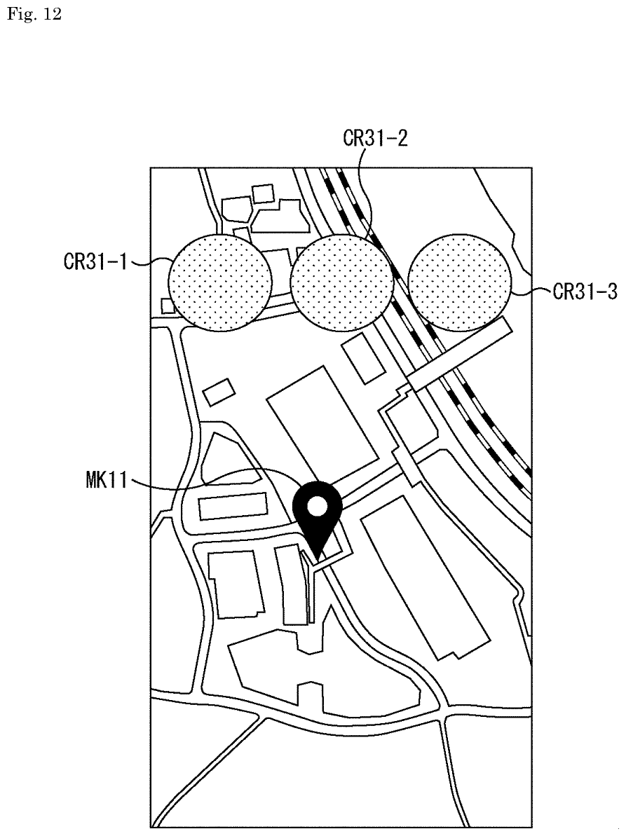

Furthermore, as illustrated in, for example, FIG. 12, it is also possible to not display, on the map screen, information such as the service area SR31 or the icon that makes it possible to specify a region that is the service area SR31. That is, it is also possible to hide the service area SR31.

Although the current position mark MK11 and the content area CR31 are displayed on the map screen in an example illustrated in FIG. 12, the service area SR31 is not displayed.

As described above, in a case where the service area SR31 is hidden, it is possible to implement a content provision method of playing back special content according to coincidental match of the content area CR31 and the service area SR31. In this case, it is possible to provide a way of enjoying different content from that in a case where the service area SR31 is displayed.

That is, there is a user for which the content area CR31 and the service area SR31 partially overlap coincidentally, and special content is played back, and this user reports (posts) a rough position of the service area SR31 by Social Networking Service (SNS).

Then, other users can also view special content by setting the content area CR31 using the report of the user.

Note that a method for presenting a content area and a service area on the map screen is not limited to the example described with reference to FIGS. 10 to 12, and may be other methods.

Furthermore, when the content area and the service area are defined on the map, a condition in a case where the respective areas partially overlap, a case where one of the areas includes the other one, or the like may be able to be set according to a purpose of a business operator.

When, for example, at least part of a content area and part of a service area overlap, it is possible to determine that these content area and service area overlap. In this case, if at least part of regions of the content area and the service area overlap, special content associated with a service area is played back.

Furthermore, when, for example, a service area is entirely included (encompassed) in a content area, or when the content area is entirely included in the service area, it is also possible to determine that the content area and the service area overlap.

Additionally, a region (range) that is a special content provision target in the content area may be defined in advance, or may be set by a business operator.

More specifically, an entire content area that also includes a region that does not overlap a service area may be a special content provision target region.

In this case, when the user terminal 11 enters the content area that overlaps the service area, special content is played back even when the user terminal 11 is at any position in this content area.

Furthermore, for example, only a region in which the content area and the service area overlap can be also a special content provision target area.

In this case, when the user terminal 11 enters the region in which the content area and the service area overlap, special content is played back.

Accordingly, even when there is a content area whose part of a region overlaps a service area, and the user terminal 11 enters this content area, if the user terminal 11 is outside a region in which the content area and the service area overlap, special content is not played back.

Hereinafter, description will be given assuming that, when at least part of regions of a content area and a service area overlap, these areas overlap. Furthermore, hereinafter, description will be given assuming that a special content provision target region is an entire content area that also includes a region that does not overlap the service area.

Additionally, when special content is played back, the user may be able to select which one of special content and element content to play back, or special content may be played back after element content is played back.

Furthermore, a method for defining (a method of designating) content areas and service areas may be a method for defining, as the content areas and the service areas, circular regions having predetermined radii whose centers are position defined by, for example, latitudes and longitudes and serving as references.

Additionally, a region whose vertex is, for example, each of a plurality of positions defined by the latitude and the longitude designated by a user or a business operator and has a polygonal shape including a rectangular shape and defined by a plurality of vertices may be a content area or a service area.

Furthermore, entry into a content area or a service area may be detected by, for example, detecting the position of the user terminal 11 by an arbitrary positioning system such as a Global Positioning System (GPS), or may be detected using various beacons. Particularly, beacons can be used to detect entry into a service area.

For example, a beacon used to detect entry into an area may be any beacon that uses an electromagnetic wave such as Bluetooth (registered trademark) or an Ultra Wide Band (UWB), uses optical means such as a Light Emitting Diode (LED), or uses a sound wave such as an ultrasonic wave.

Furthermore, in a case where a beacon is used, when a signal having a certain reception strength is detected as a signal from the beacon, entry into an area may be determined.

### <Selection of Special Content to Play Back>

Furthermore, in a case where one area (service area) is associated with a plurality of items of special content, it is possible to define which special content is selected as special content to be played back based on the above-described selection condition information or the like.

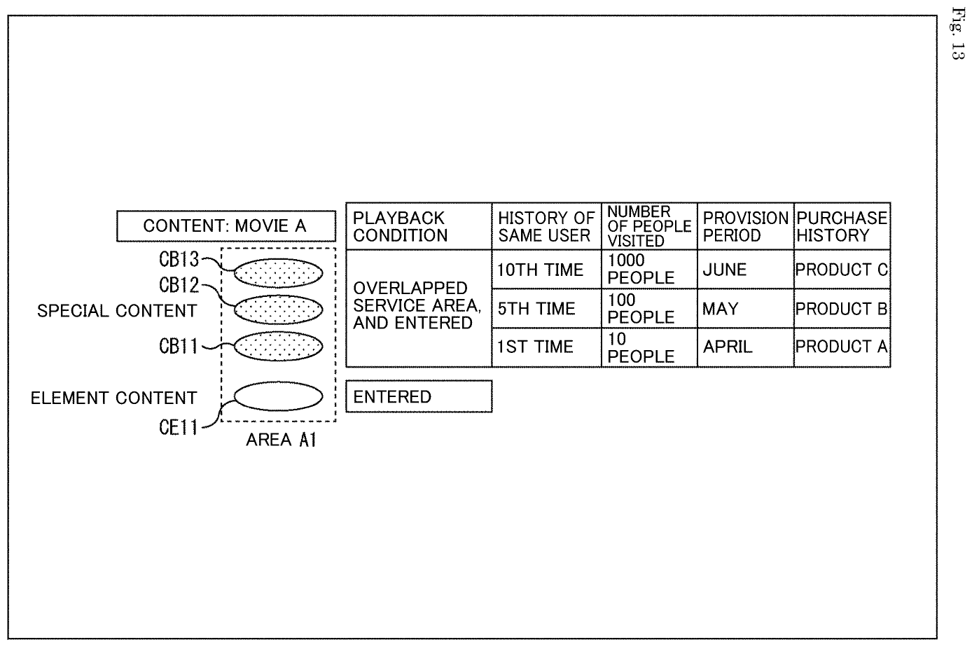

An example of a selection condition indicated by the selection condition information is illustrated in FIG. 13. Note that, in FIG. 13, parts corresponding to those in FIG. 5 are denoted by the same reference numerals and signs, and description thereof will be omitted as appropriate.

The example illustrated in FIG. 13 indicates a selection condition for each of the three special content CB11 to special content CB13 associated with the one area A1, that is, one service area.

Particularly, a condition of each item of “a history of the same user”, “the number of people visited”, a “provision period”, and a “purchase history” is illustrated as a selection condition of each special content on a right side in FIG. 13.

“The history of the same user” indicates a visiting history of a service area associated with the area A1 of the individual user, that is, the number of times of entry into a service area, more specifically, the number of times of entry into a content area that overlaps this service area. In other words, “the history of the same user” indicates a playback history of special content associated with the service area of the individual user.

Furthermore, “the number of people visited” indicates the number (total number) of users who have visited the service area associated with the area A1, that is, users who have entered a content area overlapping this service area.

The “provision period” indicates a period that is defined by a business operator and during which special content is provided, and the “purchase history” indicates a product that needs to be purchased to provide special content, and is sold (provided) by the business operator or the like.

For example, a selection condition of the special content CB11 is that the history of the same user is the “first time”, the number of people visited is “10”, the provision period is “April”, and the purchase history is a “product A”.

Hence, for example, it is assumed that a current period is April, the number of people having visited a service area associated with the area A1 so far is 10 or more, and predetermined users have purchased the product A.

In this case, when a predetermined user enters a content area overlapping a service area associated with the area A1 for the first time, the special content CB11 is selected from the special content CB11 to the special content CB13 as special content to be played back. Furthermore, the user terminal 11 of this predetermined user plays back the special content CB11.

Note that the special content to be played back may be selected at random. Furthermore, for example, the selection condition is only “the history of the same user”, and, every time a user visits a service area, a plurality of items of special content may be selected in order.

### <Configuration Example of User Terminal>

Next, configurations and operations of the user terminal 11 and the server 14 constituting the content providing system illustrated in FIG. 1 will be described.

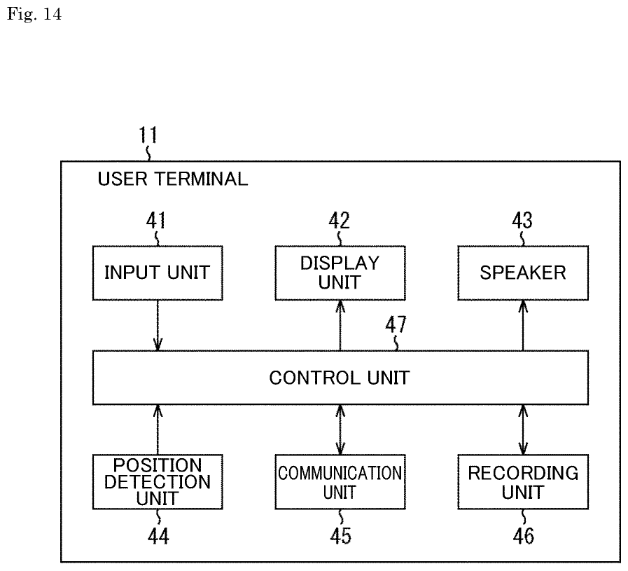

FIG. 14 is a diagram illustrating a configuration example of the user terminal 11.

In this example, the user terminal 11 includes an input unit 41, a display unit 42, a speaker 43, a position detection unit 44, a communication unit 45, a recording unit 46, and a control unit 47.

The input unit 41 includes a touch panel, a switch, a button, or the like superimposed and provided on the display unit 42, and supplies a signal matching a user's operation to the control unit 47.

The display unit 42 includes, for example, an organic Electro Luminescence (EL) panel, a liquid crystal panel, or the like, and displays various images under control of the control unit 47. The speaker 43 outputs a sound such as a voice of element content or a voice of special content under control of the control unit 47.

The position detection unit 44 includes, for example, a positioning device of an arbitrary positioning system such as a GPS, and detects (positions) the position of the user, more specifically, the user terminal 11 and supplies a detection result to the control unit 47.

Note that the position detection unit 44 includes a beacon receiver or the like, and may detect the position of the user, more specifically, entry of the user into a service area by receiving a signal emitted from a beacon. Furthermore, the position of the user terminal 11 (user) may be detected by the position detection unit 44, and, in addition, may be detected by another device that is separately owned by the user and is different from the user terminal 11. In such a case, the communication unit 45 of the user terminal 11 receives (acquires) from the another device the detection result of the position of the user terminal 11 detected by the another device.

The communication unit 45 communicates with an external device such the server 14 via a network. That is, the communication unit 45 transmits, to an external device, information supplied from the control unit 47, or receives information transmitted from an external device and supplies the information to the control unit 47.

The recording unit 46 includes, for example, non-volatile memory, and records various items of data (information) such as an application program for using the content providing service. The recording unit 46 supplies the recorded data to the control unit 47 as appropriate.

The control unit 47 controls overall operations of the user terminal 11. For example, the control unit 47 causes the display unit 42 to display an arbitrary image such as the map screen, and controls and causes the display unit 42 or the speaker 43 to play back element content or special content.

Note that a wearable device such as an Augmented Reality (AR) glass that is connected to the user terminal 11 by wire or wirelessly and can be equipped to the head of the user may display images (videos) of element content and special content. In such a case, the control unit 47 supplies the images (image data) of the element content and the special content to the wearable device, and causes the wearable device to display the images.

Similarly, an external device such as a speaker unit provided to earphones, a headphone, or the wearable device that is connected to the user terminal 11 by wire or wirelessly and can be equipped to the ears of the user may play back sounds of the element content and the special content. In such a case, the control unit 47 supplies the voices (voice data) of the element content and the special content to the external device to cause the external device to output.

Hereinafter, to simplify explanation, description will be given assuming that element content and special content are played back by the display unit 42 and the speaker 43 provided to the user terminal 11.

### <Configuration Example of Server>

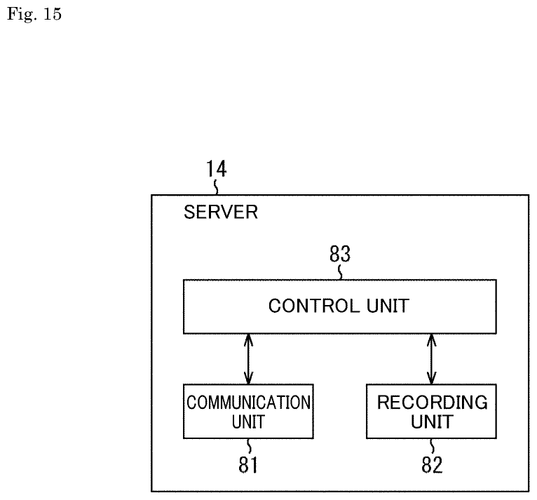

FIG. 15 is a diagram illustrating a configuration example of the server 14.

The server 14 includes a communication unit 81, a recording unit 82, and a control unit 83.

The communication unit 81 communicates with external devices such as the user terminal 11, the content provider terminal 12, and the business operator terminal 13 via the network. That is, the communication unit 81 transmits, to the external device, information supplied from the control unit 83, or receives information transmitted from the external device and supplies the information to the control unit 83.

The recording unit 82 includes, for example, a non-volatile memory, records various items of data (information) such as element content and special content, and supplies the recorded data to the control unit 83 as appropriate.

The control unit 83 controls the overall operations of the server 14. For example, the control unit 83 controls and causes the communication unit 81 to transmit element content and special content to the user terminal 11, or supply to the recording unit 82 the element content received from the content provider terminal 12 and the special content received from the business operator terminal 13 to cause the recording unit 82 to record.

### <Explanation of Content Area Setting Processing and Setting Information Reception Processing>

When, for example, the content provider terminal 12 creates the element content and the special content and transmits the element content to the server 14, the communication unit 81 of the server 14 receives the element content from the content provider terminal 12 to supply to the control unit 83. Furthermore, the control unit 83 supplies to the recording unit 82 the element content supplied from the communication unit 81 to cause the recording unit 82 to record.

Furthermore, the business operator terminal 13 selects special content provided by a business operator from among items of special content received from the content provider terminal 12. Furthermore, the business operator terminal 13 designates a service area for these selected special content, and generates service area setting information indicating the service area.

Note that the service area setting information may be any information as long as the service area setting information is information that can specify which special content the service area is associated with, and specify a region that becomes the service area.

For example, the service area setting information can be information including latitude/longitude information for specifying a center position of a service area, and a radius for specifying the size of the service area. In this case, a circular region whose center is a position indicated by the latitude/longitude information and whose radius is indicated by the service area setting information is a service area.

Furthermore, the business operator terminal 13 sets a selection condition for special content provided by the business operator as needed and generates selection condition information indicating a setting result, and also generates unique presentation information such as an advertisement to be presented at a time of playback of special content as appropriate.

As described with reference to, for example, FIG. 13, the selection condition indicated by the selection condition information can be a condition related to a user's use history (purchase history) of a service provided by a business operator, a condition related to a playback situation of each user or all users of special content, or the like. Furthermore, for example, a condition related to a provision period of special content or the like may be a selection condition.

The business operator terminal 13 transmits the selected special content, the service area setting information, the selection condition information, and the unique presentation information to the server 14.

Then, the communication unit 81 of the server 14 receives the special content, the service area setting information, and the selection condition information transmitted from the business operator terminal 13 to supply to the control unit 83.

The control unit 83 generates content information including the special content, the service area setting information, the selection condition information, and the unique presentation information supplied from the communication unit 81, and element content recorded in the recording unit 82, and supplies this content information to the recording unit 82 to cause the recording unit 82 to record.

Note that, in a case where, for example, the selection condition illustrated in FIG. 13 is defined, visitor number information indicating the number of people visiting a service area, that is, a total number of times of playback of special content associated with the service area is also stored in the content information.

When content information of predetermined content is recorded in the server 14 in this way, a user can use this content.

When the user operates the user terminal 11, starts the application program of the content providing service, and instructs to start setting a content area, the user terminal 11 starts content area setting processing.

Furthermore, the server 14 performs setting information reception processing according to the content area setting processing in the user terminal 11.

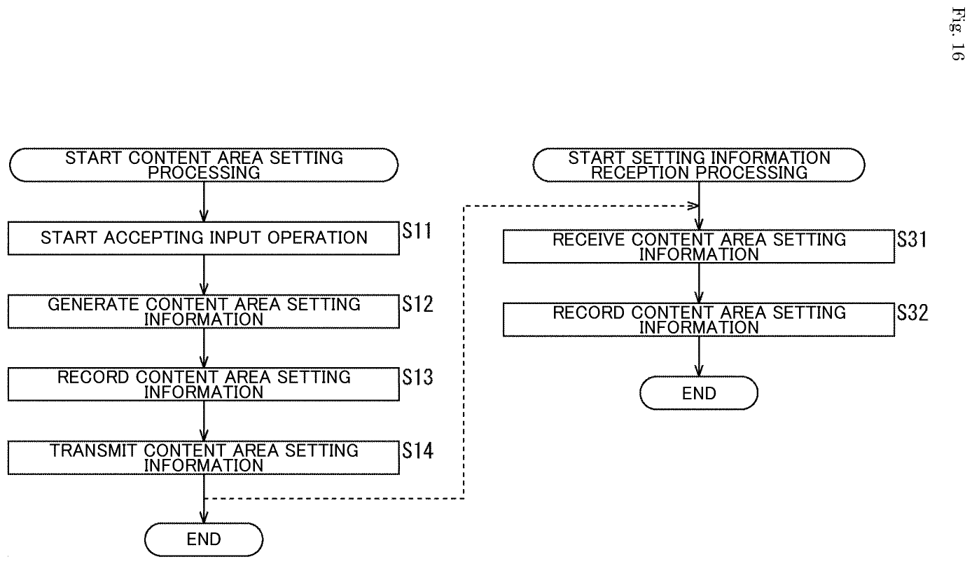

The content area setting processing of the user terminal 11 and the setting information reception processing of the server 14 will be described with reference to a flowchart of FIG. 16.

When the user terminal 11 starts the content area setting processing, in step S11, the control unit 47 causes the display unit 42 to display the map screen, and starts accepting an input operation for setting a content area.

In this case, the user terminal 11 communicates with the server 14 as needed, acquires information related to content such as arrangement positions of service areas, and displays the map screen (user interface) illustrated in, for example, FIG. 6.

The user sets content areas by operating the input unit 41, and moving the arrangement positions of the content areas on the map screen or changing the sizes of the content areas.

In step S12, the control unit 47 generates the content area setting information for specifying the content areas set (designated) by the user based on a signal supplied from the input unit 41 in response to the user's operation. In other words, the control unit 47 sets the content areas according to the user's input operation.

Note that, similarly to the service area setting information, the content area setting information may be any information as long as the content area setting information is information that can specify which element content the content area is associated with, and specify a region that becomes the content area.

In step S13, the control unit 47 supplies the content area setting information generated by processing in step S12 to the recording unit 46 to cause the recording unit 46 to record, and supplies the content area setting information to the communication unit 45, too.

In step S14, the communication unit 45 transmits to the server 14 the content area setting information supplied from the control unit 47, and finishes the content area setting processing.

Furthermore, when processing in step S14 is performed and the content area setting information is transmitted, the server 14 starts the setting information reception processing.

That is, in step S31, the communication unit 81 of the server 14 receives the content area setting information transmitted from the user terminal 11, and supplies the content area setting information to the control unit 83.

In step S32, the control unit 83 generates user information that is information including the content area setting information supplied from the communication unit 81 and related to content of each user, and supplies the generated user information to the recording unit 82 to cause the recording unit 82 to record.

In a case where, for example, the selection condition illustrated in FIG. 13 is defined, the control unit 83 generates user information including not only the content area setting information, but also use history information indicating a use history of a user of a service provided by a business operator, and playback history information of a playback history of special content associated with each service area of the user. Note that the user information may also include ID information or the like indicating a user.

When the user information is recorded, the setting information reception processing is finished.

As described above, the user terminal 11 generates the content area setting information in response to the user's operation, and the server 14 records the content area setting information.

By so doing, it is possible to provide special content associated with a service area to a user using a content area set by the user. Consequently, it is possible to provide an added value while guiding the user to the service area.

Furthermore, the user can explicitly set a content area in which the user allows the own position to be tracked, that is, in which the user transmits entry sensing information to the server 14. Consequently, it is possible to provide content in consideration of privacy.

### <Explanation of Content Playback Processing>

Furthermore, when the user sets content areas, the user subsequently can view content using the content providing service.

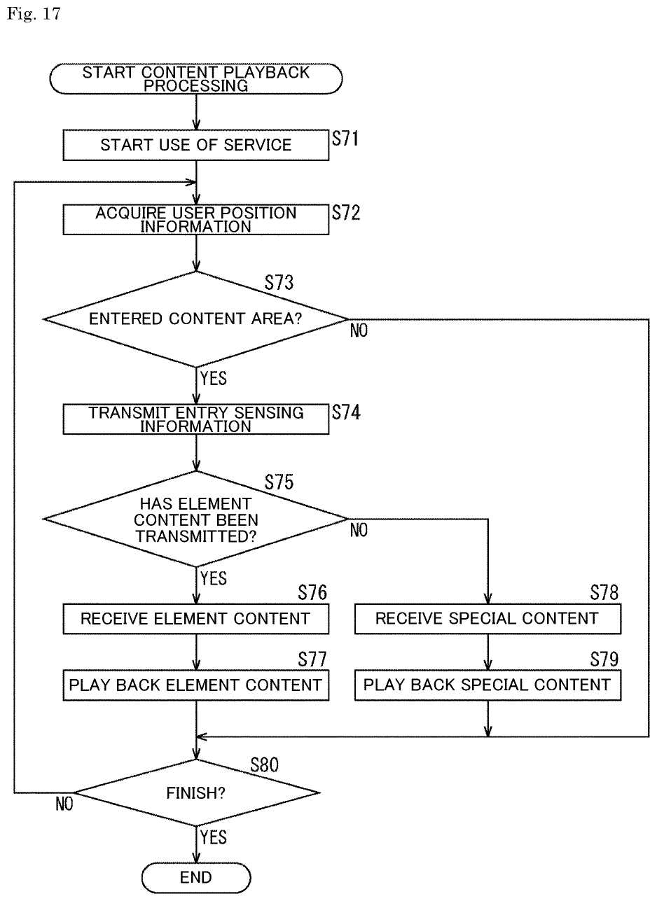

Content playback processing of the user terminal 11 will be described below with reference to a flowchart of FIG. 17.

In step S71, the control unit 47 starts using the content providing service according to a signal supplied from the input unit 41 in response to the user's operation. That is, processing for viewing content using the content providing service is started.

In step S72, the position detection unit 44 acquires user position information indicating the position of the user. That is, the position detection unit 44 detects (positions) the position of the user terminal 11 (user) by an arbitrary positioning system, and supplies the user position information indicating a detection result to the control unit 47.

Then, the control unit 47 detects entry of the user (user terminal 11) into the content area based on the user position information supplied from the position detection unit 44, and the content area setting information recorded in the recording unit 46.

When, for example, the position of the user indicated by the user position information is a position in the content area indicated by the content area setting information, it is determined that the user has entered the content area.

In step S73, the control unit 47 determines whether or not the user (user terminal 11) has entered the content area.

In a case where it is not determined in step S73 that the user has entered the content area, the processing then proceeds to step S80.

By contrast with this, in a case where it is determined in step S73 that the user has entered the content area, that is, in a case where entry of the user into the content area is detected, the control unit 47 generates entry sensing information indicating the content area in which the entry has been detected, and supplies the entry sensing information to the communication unit 45. Furthermore, the processing then proceeds to step S74.

In step S74, the communication unit 45 transmits, to the server 14, the entry sensing information supplied from the control unit 47.

Note that entry of the user (user terminal 11) into a service area may be also detected by the position detection unit 44.

In such a case, the position detection unit 44 detects entry of the user into the service area by receiving a signal emitted from a beacon for sensing entry into the service area. At this time, when the signal is received, it may be determined that the entry has been detected, and, when a reception strength of the signal is a threshold or more, it may be determined that the entry has been detected.

When the position detection unit 44 detects the entry of the user into the service area, for example, the entry sensing information also includes information indicating the service area in which the entry has been detected in addition to the information indicating the content area in which the entry has been detected.

When the entry sensing information is transmitted, element content or special content is transmitted from the server 14 to the user terminal 11 according to whether or not the content area in which the user has entered and the service area set by the business operator overlap.

That is, when there is a service area that overlaps the content area that the user has entered, the special content is transmitted. On the other hand, when there is not a service area that overlaps the content area that the user has entered, the element content is transmitted.

In step S75, the control unit 47 determines whether or not element content has been transmitted from the server 14.

In a case where it is determined in step S75 that the element content has been transmitted, in step S76, the communication unit 45 receives element content, more specifically, element content playback data transmitted from the server 14, and supplies the element content playback data to the control unit 47.

In step S77, the control unit 47 controls the display unit 42 or the speaker 43, and plays back the element content that is based on the element content playback data supplied from the communication unit 45.

For example, the control unit 47 supplies image data as the element content playback data to the display unit 42 to cause the display unit 42 to display an image (video) of the element content, and supplies voice data as the element content playback data to the speaker 43 to cause the speaker 43 to output a voice of the element content.

When the element content is played back, the processing then proceeds to step S80.

Furthermore, when it is determined in step S75 that the element content has not been transmitted, that is, in a case where special content has been transmitted, processing in step S78 is performed.

In step S78, the communication unit 45 receives the special content, more specifically, special content playback data transmitted from the server 14, and supplies the special content playback data to the control unit 47.

In step S79, the control unit 47 controls the display unit 42 and the speaker 43 to play back the special content that is based on the special content playback data supplied from the communication unit 45.

For example, the control unit 47 supplies image data as the special content playback data to the display unit 42 to cause the display unit 42 to display an image (video) of the special content, and supplies voice data as the special content playback data to the speaker 43 to cause the speaker 43 to output a voice of the special content.

Furthermore, when the communication unit 45 receives from the server 14 the unique presentation information such as an advertisement together with the special content, the control unit 47 supplies the received unique presentation information, too, to the display unit 42, and causes the display unit 42 to display the unique presentation image that is an image that is based on the unique presentation information. Consequently, for example, the advertisement or the like as the unique presentation image is displayed at an edge part of the screen together with the special content. Note that information presentation based on the unique presentation information is basically performed using only an image without presenting a voice so as not to bother the user from viewing content. Furthermore, the unique presentation image may be also displayed based on the unique presentation information at a time of playback of the element content.

When the special content is played back, the processing then proceeds to step S80.

In a case where the processing in step S77 or step S79 is performed or in a case where it is determined in step S73 that the user has not entered the content area, in step S80, the control unit 47 determines whether or not to finish the processing for viewing content.

When, for example, the user instructs to finish viewing the content, that is, finish using the content providing service, it is determined to finish the processing.

In a case where it is determined in step S80 that the processing is not to be finished yet, the processing then returns to step S72, and the above-described processing is repeated.

By contrast with this, in a case where it is determined in step S80 that the processing is to be finished, each unit of the user terminal 11 stops performing the processing, and finishes the content playback processing.

As described above, when starting using the content providing service, the user terminal 11 starts detecting entry of the user into a content area, and plays back element content or special content when the user enters the content area.

Particularly, by playing back the special content related to the element content according to whether or not the content area and a service area set by the business operator overlap, the user terminal 11 can provide an added value while guiding the user to the service area.

### <Explanation of Content Provision Processing>

Furthermore, when the user terminal 11 starts the content playback processing and the entry sensing information is transmitted from the user terminal 11, the server 14 performs the content provision processing.

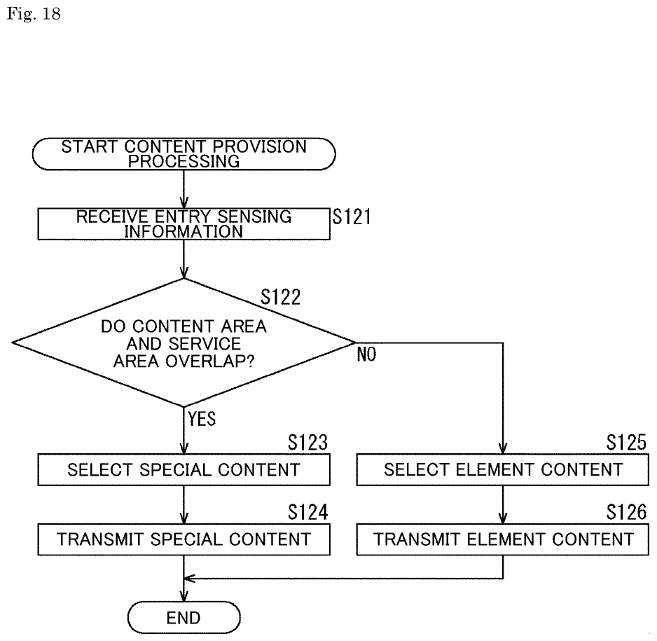

The content provision processing of the server 14 will be described below with reference to a flowchart of FIG. 18.

In step S121, the communication unit 81 receives the entry sensing information transmitted from the user terminal 11 and supplies the entry sensing information to the control unit 83.

In step S122, the control unit 83 determines whether or not a content area and a service area overlap.

That is, the control unit 83 reads the content area setting information included in the user information from the recording unit 82 for the content area that is indicated by the entry sensing information supplied from the communication unit 81 and in which the user has entered, and specifies a region that becomes this content area.

Furthermore, the control unit 83 reads the service area setting information included in the content information from the recording unit 82, and specifies whether or not there is a service area that overlaps the content area that the user has entered based on a specification result of the region that is the content area and the service area setting information. That is, the service area that overlaps the content area that the user has entered is specified.

Furthermore, when there is a service area that overlaps the control area, the control unit 83 determines that the content area and the service area overlap.

Note that whether or not the content area and the service area overlap is determined based on a condition set by a business operator.

That is, when, for example, the content area and the service area at least partially overlap, it may be determined that the content area and the service area overlap.

Furthermore, for example, it is possible to not determine that the content area and the service area overlap in a state where the content area and the service area only partially overlap, and, when the service area is entirely included in the content area or when the content area is entirely included in the service area, it is also possible to determine that the content area and the service area overlap.

Furthermore, when, for example, the user terminal 11 also detects entry into the service area, the entry sensing information includes not only information indicating the content area in which the entry has been detected, but also information indicating the service area in which the entry has been detected.

In such a case, the control unit 83 determines whether or not the content area and the service area indicated by the entry sensing information overlap based on the content area setting information and the service area setting information.

In a case where it is determined in step S122 that the content area and the service area overlap, that is, in a case where there is the service area that overlaps the content area, processing in step S123 is then performed.

In step S123, the control unit 83 selects special content associated with the service area for which it has been determined that this service area overlaps the content area that the user has entered.

In this case, in a case where the service area is associated with a plurality of items of special content, and a selection condition is set by the business operator, the control unit 83 selects one special content to play back based on the content information and the user information recorded in the recording unit 82. That is, the special content to be transmitted to the user terminal 11 is selected from among the plurality of items of special content.

More specifically, when, for example, the selection condition illustrated in FIG. 13 is defined in advance by the business operator, the control unit 83 selects special content matching with the selection condition from among the plurality of items of special content using the selection condition information and the visitor number information included in the content information, the use history information and the playback history information included in the user information, and the like.

When special content is selected, the control unit 83 reads from the recording unit 82 the selected special content, more specifically, special content playback data of the special content, and supplies the special content playback data to the communication unit 81. In this case, the control unit 83 reads the unique presentation information from the recording unit 82 as needed, and supplies the unique presentation information, too, together with the special content to the communication unit 81.

In step S124, the communication unit 81 transmits to the user terminal 11 the special content supplied from the control unit 83. In this case, when the unique presentation information is also supplied together with the special content from the control unit 83, the communication unit 81 transmits the special content and the unique presentation information to the user terminal 11.

Furthermore, the control unit 83 updates the visitor number information included in the content information, and the playback history information included in the user information in response to transmission of the special content as appropriate.

When the special content is transmitted to the user terminal 11, the content provision processing is finished.

Furthermore, in a case where it is determined in step S122 that the content area and the service area do not overlap, that is, in a case where there is no service area that overlaps the content area, processing in step S125 is then performed.

In step S125, the control unit 83 selects element content associated with the content area that the user has entered.

Furthermore, the control unit 83 reads the selected element content, more specifically, element content playback data of the element content from the recording unit 82, and supplies the element content playback data to the communication unit 81.

In step S126, the communication unit 81 transmits to the user terminal 11 the element content supplied from the control unit 83, and finishes the content provision processing. Note that, as described above, the unique presentation information may be also transmitted together with the element content.

As described above, the server 14 determines whether or not the content area and the service area overlap, and transmits special content or element content to the user terminal 11 according to a determination result.

By so doing, it is possible to provide, to a user, special content associated with a service area set by the business operator and related to element content. Consequently, it is possible to provide an added value while guiding the user to the service area. Furthermore, by so doing, it is possible to increase the number of accesses from business operators to users who do not directly have business with the business operators.

### <Configuration Example of Computer>

By the way, the above-described series of processing can be executed by hardware or can be executed by software. In the case where the series of processing is executed by software, a program that configures the software is installed on a computer. Here, the computer includes, for example, a computer built in dedicated hardware, a general-purpose personal computer on which various programs are installed to be able to execute various functions, and the like.

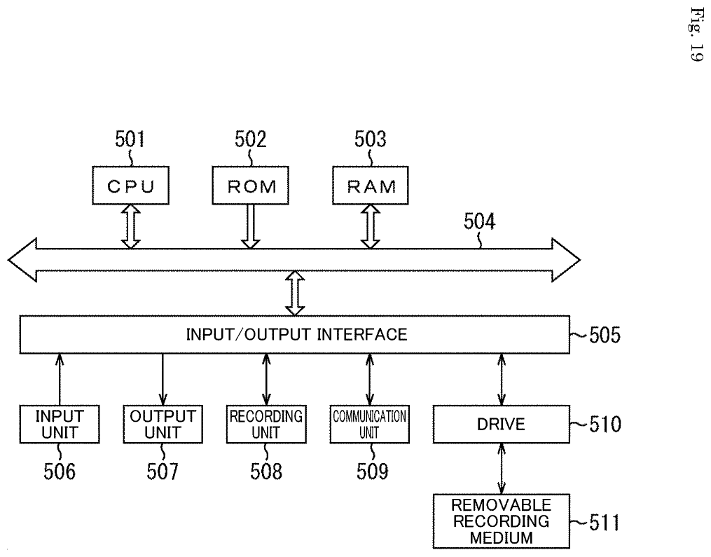

FIG. 19 is a block diagram illustrating a configuration example of computer hardware that executes the above-described series of processing using a program.

In the computer, a Central Processing Unit (CPU) 501, a Read Only Memory (ROM) 502, and a Random Access Memory (RAM) 503 are connected to one another by a bus 504.

The bus 504 is further connected with an input/output interface 505. The input/output interface 505 is connected with an input unit 506, an output unit 507, a recording unit 508, a communication unit 509, and a drive 510.

The input unit 506 includes a keyboard, a mouse, a touch panel, a microphone, an imaging element, and the like. The output unit 507 includes a display, a speaker, and the like. The recording unit 508 includes a hard disk, a nonvolatile memory, and the like. The communication unit 509 includes a network interface and the like. The drive 510 drives a removable recording medium 511 such as a magnetic disk, an optical disc, a magneto-optical disk, or a semiconductor memory.

In the computer configured as described above, the CPU 501 loads, for example, a program recorded in the recording unit 508 into the RAM 503 through the input/output interface 505 and the bus 504, executes the program, and thereby performs the series of processing.

The program to be executed by the computer (CPU 501) can be recorded on, for example, the removable recording medium 511 as a packaged medium and provided. Furthermore, the program can be also provided through a wired or wireless transmission medium such as a local area network, the Internet, or digital satellite broadcasting.

In the computer, the program can be installed on the recording unit 508 through the input/output interface 505 by attaching the removable recording medium 511 to the drive 510. Furthermore, the program can be received by the communication unit 509 through a wired or wireless transfer medium and installed on the recording unit 508. In addition, the program can be installed in advance on the ROM 502 or the recording unit 508.

Note that the program executed by a computer may be a program that performs processing in chronological order in order described in this description or may be a program that performs processing in parallel or at a necessary timing such as a time when the program is invoked.

Furthermore, embodiments of the present technique are not limited to the above-described embodiments and can be changed in various ways without departing from the gist of the present technique.

For example, the present technique may be configured as cloud computing in which a plurality of devices share and cooperatively process one function via a network.

Furthermore, each step described in the above-described flowchart can be executed by one device or executed in a shared manner by a plurality of devices.

Furthermore, when a single step includes a plurality of processing, the plurality of processing included in the single step can be executed by a single device, or in a shared manner by a plurality of devices.

Furthermore, the present technique can be also configured as follows.

(1)

An information processing device includes: a control unit that, when a user terminal of a user enters a content area, specifies a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and a communication unit that transmits to the user terminal the related content associated with the service area specified by the control unit.

(2)

In the information processing device described in (1), when there is not the service area that overlaps the content area that the user terminal has entered, the communication unit transmits to the user terminal the element content associated with the content area that the user terminal has entered.

(3)

In the information processing device described in (1) or (2), the related content is content having a same theme as a theme of the element content.

(4)

In the information processing device described in any one of (1) to (3), when the content area and the service area at least partially overlap, the control unit determines that the service area and the content area overlap.

(5)

In the information processing device described in any one of (1) to (3), when the service area is entirely included in the content area, the control unit determines that the service area and the content area overlap.

(6)

In the information processing device described in any one of (1) to (3), when the content area is entirely included in the service area, the control unit determines that the service area and the content area overlap.

(7)

In the information processing device described in any one of (1) to (6), the element content includes at least one of an image and a voice.

(8)

In the information processing device described in any one of (1) to (7), the related content includes at least one of an image and a voice.

(9)

In the information processing device described in any one of (1) to (8), the communication unit transmits unique presentation information unique to the business operator together with the related content to the user terminal.

(10)

In the information processing device described in (9), the unique presentation information is image information.

(11)

In the information processing device described in (9) or (10), the unique presentation information is information for presenting an advertisement of the business operator.

(12)

In the information processing device described in any one of (1) to (11), when there are a plurality of items of the related content associated with the service area, the control unit selects the related content to be transmitted to the user terminal from among the plurality of items of related content.

(13)

In the information processing device described in (12), the control unit selects the related content based on a condition set by the business operator in advance.

(14)

An information processing method includes at an information processing device:
when a user terminal of a user enters a content area, specifying a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and transmitting to the user terminal the related content associated with the specified service area.
   (15)

A program causing a computer to execute processing including the steps of: when a user terminal of a user enters a content area, specifying a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and transmitting to the user terminal the related content associated with the specified service area.

(16)

An information processing device that plays back element content or related content related to the element content includes:
a control unit that sets a content area in which the element content is provided in response to an operation of a user, and detects entry of the information processing device into the content area based on content area setting information indicating the content area; and
a communication unit that, when the entry of the information processing device into the content area is detected, receives the related content associated with a service area that is set by a business operator that provides the related content and in which the related content is provided, and that overlaps the content area that the information processing device has entered, and
the control unit plays back the received related content.
   (17)

In the information processing device described in (16), when there is not the service area that overlaps the content area that the information processing device has entered, the control unit plays back the element content associated with the content area that the information processing device has entered.

(18)

In the information processing device described in (17), when there is not the service area that overlaps the content area that the information processing device has entered, the communication unit receives the element content associated with the content area that the information processing device has entered.

(19)

The information processing device described in any one of (16) to (18) further includes a position detection unit that detects a position of the information processing device, and
the control unit detects the entry of the information processing device into the content area based on a detection result of the position obtained by the position detection unit and the content area setting information.
   (20)

In the information processing device described in any one of (16) to (19), the control unit starts detecting the entry of the information processing device into the content area after start of use of a service of providing the element content and the related content.

(21)

In the information processing device described in any one of (16) or (20), the related content is content having a same theme as a theme of the element content.

(22)

In the information processing device described in any one of (16) to (21), when the content area and the service area at least partially overlap, it is determined that the service area and the content area overlap.

(23)

In the information processing device described in any one of (16) to (21), when the service area is entirely included in the content area, it is determined that the service area and the content area overlap.

(24)

In the information processing device described in any one of (16) to (21), when the content area is entirely included in the service area, it is determined that the service area and the content area overlap.

(25)

In the information processing device described in any one of (16) to (24), the element content includes at least one of an image and a voice.

(26)

In the information processing device described in any one of (16) to (25), the related content includes at least one of an image and a voice.

(27)

In the information processing device described in any one of (16) to (26), the communication unit receives unique presentation information unique to the business operator together with the related content, and the control unit plays back the received related content and the unique presentation information.

(28)

In the information processing device described in (27), the unique presentation information is image information.

(29)

In the information processing device described in (27) or (28), the unique presentation information is information for presenting an advertisement of the business operator.

(30)

In the information processing device described in any one of (16) to (29), when there are a plurality of items of the related content associated with the service area, the related content to be played back is selected from among the plurality of items of related content based on a condition set by the business operator in advance.

(31)

An information processing method includes at an information processing device that plays back element content or related content related to the element content:
setting a content area in which the element content is provided in response to an operation of a user, and detecting entry of the information processing device into the content area based on content area setting information indicating the content area;
when the entry of the information processing device into the content area is detected, receiving the related content associated with a service area that is set by a business operator that provides the related content and in which the related content is provided, and that overlaps the content area that the information processing device has entered; and playing back the received related content.
   (32)

A program causes a computer that controls an information processing device that plays back element content or related content related to the element content to execute processing including the steps of:
setting a content area in which the element content is provided in response to an operation of a user, and detecting entry of the information processing device into the content area based on content area setting information indicating the content area;
when the entry of the information processing device into the content area is detected, receiving the related content associated with a service area that is set by a business operator that provides the related content and in which the related content is provided, and that overlaps the content area that the information processing device has entered; and playing back the received related content.

[Reference Signs List]

| | |
|---|---|
| 11 | User terminal |
| 12 | Content provider terminal |
| 13 | Business operator terminal |
| 14 | Server |
| 41 | Input unit |
| 42 | Display unit |
| 43 | Speaker |
| 44 | Position detection unit |
| 45 | Communication unit |
| 46 | Recording unit |
| 47 | Control unit |
| 81 | Communication unit |
| 82 | Recording unit |
| 83 | Control unit |

1. An information processing device comprising:
a control unit that, when a user terminal of a user enters a content area, specifies a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and
a communication unit that transmits to the user terminal the related content associated with the service area specified by the control unit.

2. The information processing device according to claim 1, wherein, when there is not the service area that overlaps the content area that the user terminal has entered, the communication unit transmits to the user terminal the element content associated with the content area that the user terminal has entered.

3. The information processing device according to claim 1, wherein the related content is content having a same theme as a theme of the element content.

4. The information processing device according to claim 1, wherein the element content includes at least one of an image and a voice.

5. The information processing device according to claim 1, wherein the related content includes at least one of an image and a voice.

6. The information processing device according to claim 1, wherein the communication unit transmits unique presentation information unique to the business operator together with the related content to the user terminal.

7. The information processing device according to claim 6, wherein the unique presentation information is image information.

8. The information processing device according to claim 6, wherein the unique presentation information is information for presenting an advertisement of the business operator.

9. The information processing device according to claim 1, wherein, when there are a plurality of items of the related content associated with the service area, the control unit selects the related content to be transmitted to the user terminal from among the plurality of items of related content.

10. The information processing device according to claim 9, wherein the control unit selects the related content based on a condition set by the business operator in advance.

11. An information processing method comprising, at an information processing device:
when a user terminal of a user enters a content area, specifying a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and
transmitting to the user terminal the related content associated with the specified service area.

12. A program causing a computer to execute processing including the steps of: when a user terminal of a user enters a content area, specifying a service area based on content area setting information and service area setting information, the content area being set by the user and providing element content, the service area overlapping the content area that the user terminal has entered, the content area setting information indicating the content area, and the service area setting information being set by a business operator that provides related content related to the element content, and indicating the service area in which the related content is provided; and
transmitting to the user terminal the related content associated with the specified service area.

13. An information processing device that plays back element content or related content related to the element content, the information processing device comprising:
a control unit that sets a content area in which the element content is provided in response to an operation of a user, and detects entry of the information processing device into the content area based on content area setting information indicating the content area; and
a communication unit that, when the entry of the information processing device into the content area is detected, receives the related content associated with a service area that is set by a business operator that provides the related content and in which the related content is provided, and that overlaps the content area that the information processing device has entered, and
wherein the control unit plays back the received related content.

14. The information processing device according to claim 13, wherein, when there is not the service area that overlaps the content area that the information processing device has entered, the control unit plays back the element content associated with the content area that the information processing device has entered.

15. The information processing device according to claim 13, further comprising a position detection unit that detects a position of the information processing device,
wherein the control unit detects the entry of the information processing device into the content area based on a detection result of the position obtained by the position detection unit and the content area setting information.

16. The information processing device according to claim 13, wherein the control unit starts detecting the entry of the information processing device into the content area after start of use of a service of providing the element content and the related content.

17. The information processing device according to claim 13, wherein
the communication unit receives unique presentation information unique to the business operator together with the related content, and
the control unit plays back the received related content and the unique presentation information.

18. The information processing device according to claim 13, wherein, when there are a plurality of items of the related content associated with the service area, the related content to be played back is selected from among the plurality of items of related content based on a condition set by the business operator in advance.

19. An information processing method comprising at an information processing device that plays back element content or related content related to the element content:
setting a content area in which the element content is provided in response to an operation of a user, and detecting entry of the information processing device into the content area based on content area setting information indicating the content area;
when the entry of the information processing device into the content area is detected, receiving the related content associated with a service area that is set by a business operator that provides the related content and in which the related content is provided, and that overlaps the content area that the information processing device has entered; and
playing back the received related content.

20. A program causing a computer that controls an information processing device that plays back element content or related content related to the element content to execute processing comprising the steps of:
setting a content area in which the element content is provided in response to an operation of a user, and detecting entry of the information processing device into the content area based on content area setting information indicating the content area;
when the entry of the information processing device into the content area is detected, receiving the related content associated with a service area that is set by a business operator that provides the related content and in which the related content is provided, and that overlaps the content area that the information processing device has entered; and
playing back the received related content.
